(19) United States
(12) Patent Application Publication
(10) Pub. No.: US 2004/0193534 A1
(43) Pub. Date: Sep. 30, 2004

(54) Paperless mortgage plus HUB concept and clearinghouse processing solutions

(76) Inventor: Cathy Carswell Reis, San Clemente, CA (US)

Correspondence Address: CATHY CARSWELL REIS, 3910 CALLE REAL, SAN CLEMENTE, CA, 92673, US

(21) Appl. No.: 10/339,210

(22) Filed: Mar. 27, 2003

(51) Int. Cl. G06F 17/60

(52) U.S. Cl. 705/38; 705/35

(57) ABSTRACT

My plan for best execution reduces the cost of a mortgage by more than $2,000.00. The plan includes marketing and technology solutions that will eliminate much overhead and present costs, associated with processing mortgage transactions.

The Consumer is connected directly to various lender's underwriting engines, and other real estate participants, through Sybase Integration Hub, which is connected to DST AWD Technologies, which includes DST Output, and MFDS Call Center.

The solution provides the consumer with the ability to eliminate the loan officer's commissions, plus provides discounts for title, escrow, etc. The wholesale banker/broker is equipped with straight through processing and call center technologies, to enable our clients to realize a variable cost origination, with minimal overhead. Further discounts, can be passed on to the consumer, plus other than mortgage profits, can be realized by the mortgage banker.

### SUMMARY

I am the original author of the described validation and communications clearinghouse process for the real estate industry, and I am seeking patent protection for this methodology. I hope that you will award this protection, as quickly as possible, so that we can capitalize this venture. This solution will allow CPS clients a unique competitive advantage in the real estate industry, in addition, to the tremendous cost savings through outsourced paper and communications processing.

### BACKGROUND OF INVENTION

Fragmented communications have been a consistent problem in the real estate industry. The lack of standardization creates costly process requirements for processing mortgage transactions. As a result of this need for standardization, a best of breed's software solution, within a turnkey marketing plan has been designed for those parties to use. “The Paperless Mortgage Plus HUB Concept” And Clearinghouse Processing Solutions, allows the mortgage bank and/or broker to outsource all paper and people requirements, and to change their role as sales agents of this solution to their point of sale clients. This solution will significantly reduce the cost for obtaining a mortgage, which is intended to be passed on to the consumer.

### PLAN OVERVIEW

DST's AWD (Automated Work Distributor), the heart of the CPS Solution provides the ability to realize an almost “paperless” fulfillment solution through business process management software (imaging, workflow and work management). AWD accepts the required documentation and other loan conditions specified by the automated underwriting engine through; hard copy, fax or email and places the images in an electronic file. AWD, then, through defined business rules, manages the conditions and triggers, automatically, communications necessary to keep the participants (loan officer, borrower, Realtor, etc.), “up to date” on the status of the process and alerts them of items that have not been received or tasks that must be accomplished. “Best of Breeds” software applications selected to accomplish the “paperless mortgage plus other than mortgage profits”, online to DST Systems' AWD software, includes, but not limited to:

Real Estate Sales Contract (WINForms) (optional)—Data generated from the California Association of Realtors' electronic real estate form software is transmitted to DST's AWD software directly, workflow and loan approvals begin at the initiation of the buying process. WINForms enables the Realtor to prepare real estate transaction related forms electronically and to transmit them to other parties involved in the transaction. The data contained in the deposit receipt can be populated into a loan application (1003).

The Paperless Mortgage (1003 data)—CPS' Solution towards The Paperless Mortgage enables the loan officer or “point of sale” client to enter information in any form of medium of communications and transmit the 1003 data directly into our solution, DST Systems, which records and sends all required correspondence, throughout the loan origination process, until the close of the transaction. Workflow can begin at the validation stage of the loan process, (records all paper conditions and correspondence until the close of the transaction), or at the very beginning of the process, whereas the client out sources all correspondence and record keeping to our call center and help desk processing solution. In this case AWD would be responsible for sending the 1003 data through a credit agency and the underwriting engines required for loan approval, in addition to generating disclosures generated by state and disclosures. DST's communications software, (i.e. DST Output) also provides the ability to compare mortgage products and their characteristics. DST Output also allows for cross selling opportunities after the sale of the loan, through sophisticated and targeted direct mail to the lender's customer base.

Underwriter Information entered into The Paperless Mortgage, or any other loan officer software, will be electronically transmitted to Desktop Underwriter, Loan Prospector, Clues, or any lender's proprietary automated underwriting engine

Other Income Opportunities Through DST Output—Provides other income opportunities to CPS Lender clients, in addition to better cross marketing solutions for outbound correspondence, either through direct or electronic mail.

### CPS TRADE SECRETS AND INDUSTRY EXPOSURE TO THE DST SOLUTION

CPS has relied on Trade Secret Law, copyright protection and nondisclosures for protection, until the CPS solution can be patented. The following are precautions taken by CPS and Reis to protect its interests:

DST Systems has recognized CPS Business Plan in its contract with CPS, and has signed off on certain protected clients (See Exhibit A-CPS Protected Client List as of October 2002, and Exhibit B-Vendor clients and others introduced to DST Systems.

Fannie Mae—Desktop Originator (DO) provides a database of lender's products and pricing, which can be uploaded to any loan officer software. Desktop Underwriter (DU) is automated underwriting software that determines a borrower's credit worthiness. Reis and CPS had been under contract to Fannie Mae as a consultant. My best of breed's software solutions were protected in third party concepts acknowledged by Fannie Mae.

Freddie Mac—Loan Prospector, like Desktop Underwriter, is automated underwriting software that determines the borrower's credit worthiness. CPS has a confidentiality Agreement with Freddie Mac.

Mortgage Bankers Association of America (Mortgage flex, Eastern, Gallagher, Interlinq, Point, Genesis, Contour, etc.)—Mortgage banking trade association and LOS vendors within the mortgage industry. Most LOS Systems are already connected to Fannie Mae and Freddie Mac's underwriting solutions, and have built to their standards. The validation process will be offered on a ASP Basis to lenders and brokers, very simply, through a simple file export through their systems.

The DST Output solution allows CPS Clients to distribute mortgage rates and products more efficiently and allows the lender better ability to cross sell and up sell other than mortgage opportunities, through DST Output's direct mail software platform. DST Output also recognized the CPS Plan in its contract with CPS, and has also protected certain clients.

### SYSTEM DEVELOPMENT PLAN OVERVIEW

### System Development—Phase 1

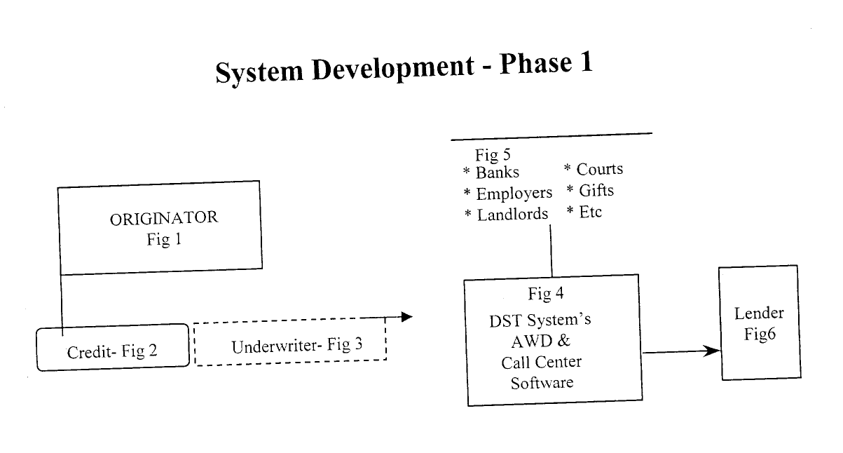

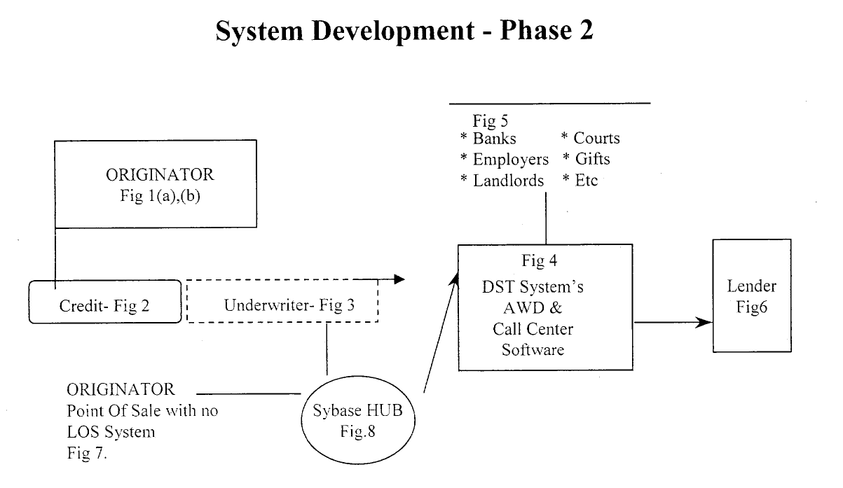

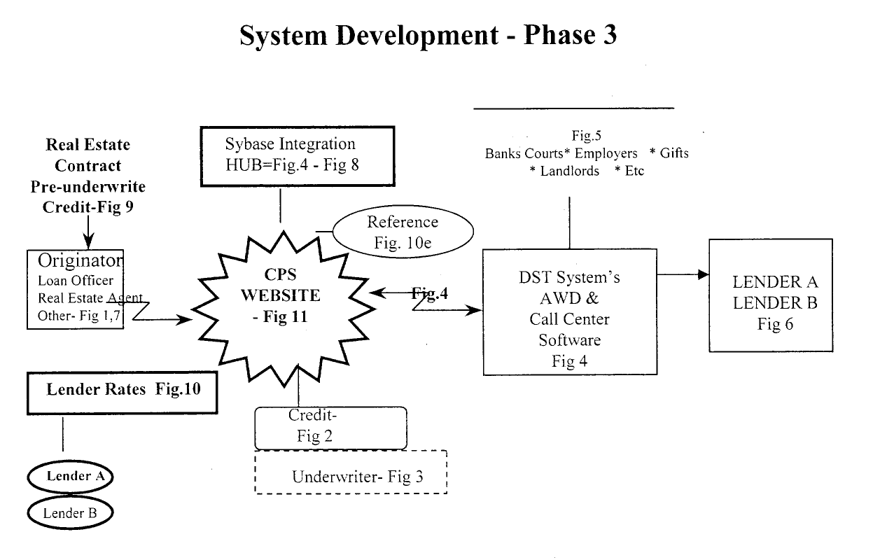

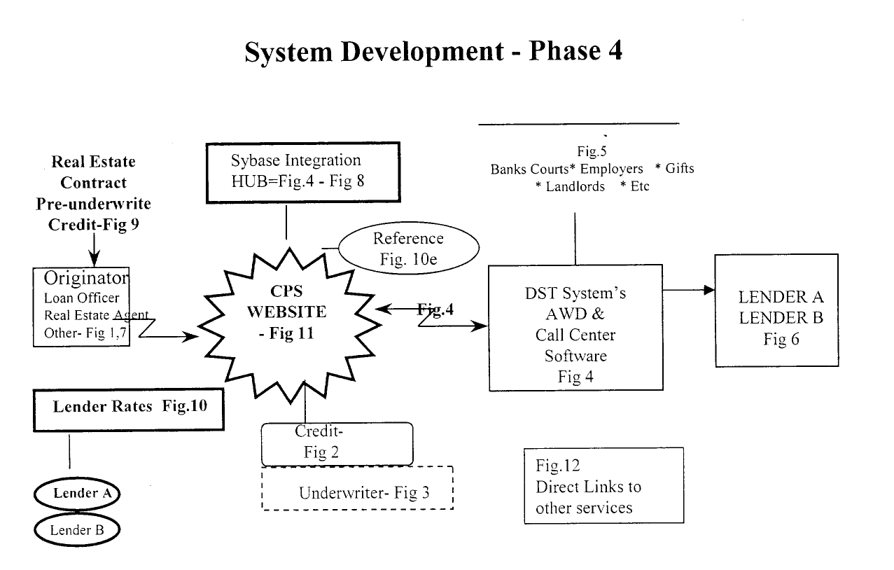

FIG. 1. (a) The Originator. The originating entity enters the data into any loan origination software “LOS” (Calyx, Contour, Genesis, Eastern, MortgageFlex, etc.) by direct transmission electronically from the loan officer software, email, fax, web page or hard copy and sent to DST Systems to accommodate the processing and tracking of their loan conditions. In the future data will also be entered verbally or scanned, utilizing optical character recognition technology “OCR”. Most mortgage banks and brokers will use their existing LOS System to capture the necessary data. Most will run their own credit, and transmit directly to Desktop Underwriter “DU” through Desktop Originator “DO”, Loan Prospector “LP” or any other lender proprietary artificial intelligence underwriting engine (FIG. 2 and FIG. 3).

FIG. 2. (b) Point of Sale—Credit. The originator enters the information necessary to obtain the loan, but does not have the ability to run credit or access the desired underwriting engine. The information is faxed, emailed or sent in hard copy (hard copy is scanned) to DST Systems Automated Work Distributor software “AWD”. AWD transmits the data to the CPS LOS system (FIG. 2), and the data is transmitted to the desired underwriting engine (FIG. 3).

FIG. 3. (b) Point Of Sale—Underwriter. Once the underwriting engine receives the data, the borrower(s) is judged by his or her credit and income characteristics, and the loan to value of the property, and a credit decision is made “approved or denied.” If an approval is granted, the underwriting engine stipulates certain conditions, which are electronically transmitted to AWD.

FIG. 4. DST Systems' Automated Work Distributor “AWD” and Call Center Software Once the approval and associated conditions are received from the underwriting engine into AWD, each item is prioritized, and the approval and conditions are transmitted to the originator, borrower, and any other designated participant in the loan origination process (title, escrow, etc.), by fax, email or letter, depending upon the desire of the recipient. AWD prioritizes each work item and tracks the status of each condition. As AWD receives the conditions by fax, email or hard copy (indexed and scanned), they are filed into an electronic file. If a condition is not received within the designated period of time, the responsible party (appraiser, borrower, escroc, etc.) is automatically notified, by fax or email, that receipt of the item is delinquent.

FIG. 5. Loan Processing/Verifications “conditions” Documents required by the underwriting engine and/or underwriter for final loan approval (paycheck stubs, bank statements, tax returns, appraisal, etc.). AWD performs the verification process, either through online correspondence or direct mail. Conditions—As the requests for verifications and all loan conditions are received by the responsible parties (depositories, employers, mortgagees, landlords, down payment gift providers, etc.), they transmit the required information back to AWD, to distribute to those that need to view the loan file Credit is ordered, if applicable, to determine the credit worthiness of the borrower(s). Appraisal is ordered if applicable to determine the value of the property. The appraisal is either scanned, if hard copy, or electronically transmitted by the appraiser. Closing—Communicating with escrow, Title Company or other entity responsible for the distribution of funds, and funding the loan Documents—Preparation of the loan documents for signature by the borrower(s) and transmittal to the escrow or closing table.

FIG. 6. Lender—Once all conditions have been satisfied, the electronic file is transmitted to the lender or the lender's designated mortgage insurance company contract underwriter for validation of the accuracy of the information initially entered by the originator or point of sale.

### Systems Development—Phase 2

CPS Accomplishes the actual connection of the direct links to various sources through the Hub technology. In phase 2, CPS methodology includes FIGS. 1 through 6, plus:

FIG. 7. Point Of Sale Originator. The Point Of Sale Originator will submit its data through integration HUB technology to route the information based on rules prior to the credit and underwriting. (FIG. 2 and 3.)

FIG. 8. Sybase (Providers of hub integration software)—Sybase, and other providers of Hub integration software, allow connectivity through a central hub, simplifying the connection of participating software products and vendors associated with the CPS solution first, and then transmitted to AWD, Credit, Underwriting, etc. through the HUB, based on predefined rules.

### Systems Development—Phase 3

CPS adds the ability to Pre-Underwrite prior to purchasing a home. In phase 3, CPS methodology includes FIGS. 1 through 8, plus:

FIG. 9. Real Estate Contract Pre-Underwriting Through CPS WEB SITE—Direct links to various automated underwriting engines (Fannie Mae's DU, Freddie Mac's LP, Countrywide's CLUES, Indy Mac's EMITS, etc.) PRIOR TO BUYING THE HOME.

FIG. 10. Lender Rates and Reference—Access to databases containing information relating to lenders mortgage products and related items, such as rates and advertisements. Additional reference sights are to Societas' global database, ALLRegs, local and state guidelines, etc.

FIG. 11. CPS Website provides all outbound and incoming communication support to real estate and mortgage related services (credit, title, flood, etc) from direct links built from the consumer level, with correspondence and workflow beginning prior to the buying process. This can be accomplished from our alliance with DST Output, Sybase, and DST AWD software integrated to the various software used by the real estate industry.

### Systems Development—Phase 4

FIG. 12. E-Mail—Provides communication with non-mortgage related business opportunities. (PurchasePro VAN, etc.). The consumer direct links through the CPS Web site to Sybase HUB integration, which disburses the order to various other than mortgage services.

1. I am the original author of the “Clearinghouse Processing Solutions”, as outlined. I have chosen DST Output, and DST AWD and call center software to accomplish this objective for the real estate industry. The combination of these relationships allows the mortgage company to outsource all communication requirements, both outbound and inbound. Both parties have recognized this real estate plan, as my own, and have protected my client base, through my company's existing contracts.

2. I am the original author of the total integration solution, (the connectivity of various best of breeds software applications described in the phased implementation plan provided), which allows the mortgage bank and broker to change their roles, to more productive ones. The integrated solution will allow the wholesale bank and/or broker to sell “The Paperless Mortgage Plus HUB Concept” to their point of sale clients. This level of support will form strategic partnerships with their client base.

3. I am the original author of the Certified Consumer Paperless Mortgage, which allows the consumer to apply for a loan direct to CPS Lender Sponsors, without any Loan Origination Software Requirement. The consumer will submit their information electronically, or by a hand written application to the CPS Website, which distributes qualified leads to CPS clients. The AWD process starts directly from the consumer, and will perform straight through processing, as described in Phase Three of the Phased Implementation Plan. This allows the mortgage bank or broker to almost completely remove staff requirements for the process, thereby eliminating costly overhead and fees. They simply become remarketers of the Paperless Mortgage process, directed at the consumer. CPS will conduct a certified consumer media campaign, on behalf of its client base. The traditional loan officer fee will be passed on to the consumer, with 10 percent, to state and local governments, towards community redevelopment.
